(19) United States
(12) Patent Application Publication
(10) Pub. No.: US 2025/0111654 A1
(43) Pub. Date: Apr. 3, 2025

(54) METHODS FOR GENERATION OF SYNTHETIC SV2A PET FROM MRI IMAGES

(71) Applicant: YALE UNIVERSITY, New Haven, CT (US)

(72) Inventors: Rajiv Radhakrishnan, New Haven, CT (US); Chi Liu, New Haven, CT (US); Patrick Worhunsky, New Haven, CT (US); Xinyuan Zheng, New Haven, CT (US)

(21) Appl. No.: 18/900,131

(22) Filed: Sep. 27, 2024

Related U.S. Application Data
(60) Provisional application No. 63/586,329, filed on Sep. 28, 2023.

(51) Int. Cl. G06V 10/774; G06V 10/82

(52) U.S. Cl. CPC G06V 10/774; G06V 10/82; G06V 2201/03

(57) ABSTRACT

Provided herein are methods of generating positron emission tomography (PET) images from magnetic resonance imaging (MRI) data. In some aspects, the methods can be used for subjects having a condition corresponding to a biomarker of interest, such as a biomarker associated with a brain disorder.

### CROSS-REFERENCE TO RELATED APPLICATION

This application claims priority under 35 U.S.C. § 119(e) to U.S. Provisional Patent Application No. 63/586,329, filed Sep. 28, 2023, the disclosure of which is hereby incorporated by reference in its entirety.

### BACKGROUND OF THE INVENTION

Positron emission tomography (PET) imaging provides molecular information about the brain that is not available through other imaging modalities. However, the use and accessibility of PET imaging is limited because it is expensive; requires specialized scanners and expertise, which limits its use few centers; and uses radioactive isotopes, which limit its use in vulnerable populations such as adolescents, and pregnant women.

Accordingly, there is a need in the art for methods that improve on existing methods of imaging by obtaining molecular-level information without having to perform PET imaging. The present invention addresses this need.

### BRIEF SUMMARY

In one aspect, the present disclosure generally relates to a computer-implemented method of training a model to generate positron emission tomography (PET) images from magnetic resonance imaging (MRI) images, the method comprising: selecting a healthy dataset, the healthy dataset including paired MR and PET images from healthy subjects; selecting a target dataset, the target dataset including paired MR and PET images from subjects having a condition corresponding to a biomarker of interest; creating a training dataset from the combination of healthy dataset and the target dataset; training a machine learning model using the training dataset. In some aspects, the MR images comprise at least one MR sequence image. In some aspects, the MR sequence image comprises an MR T1 image, or MR T2 image, or a combination of images acquired using more than one MR sequences. In some aspects, the biomarker of interest is a synaptic density tracer. In some aspects, the biomarker of interest is synaptic vesicle protein 2A (SV2A). In some aspects, the condition is a brain disorder. In some aspects, the brain disorder a neuropsychiatric disorder. In some aspects, the neuropsychiatric disorder is selected from the group consisting of Alzheimer's disease, mild cognitive impairment, major depressive disorder, schizophrenia, post-traumatic stress disorder, autism spectrum disorders, anxiety disorders, bipolar disorder and substance use disorders. In some aspects, the substance use disorder is cannabis use disorder. In some aspects, the machine learning model comprises a deep learning model. In some aspects, the deep learning model comprises an encoder-decoder with 3D convolution layers with ReLU activation operators. In some aspects, the machine learning model comprises a deep convolution neural network or other networks such as a diffusion network. In some aspects, the machine learning model comprises a network model trained using: a. MR T1 or T2 to BP 60 PET image; b. MR T1 or T2 to BP 90 PET image; or c. MR T1 or T2 to distribution volume ratio (DVR) PET image; or d. MR T1 or T2 to SUV PET image. In some aspects, the training comprises patch-based training. In some aspects, the patch-based training comprises extracting at least four random patches for each epoch from each training image. In some aspects, the MR and PET images are subjected to preprocessing prior to training the machine learning model. In some aspects, the preprocessing comprises segmentation and co-registration of the MR and PET images.

Moreover, in one aspect, the present disclosure generally relates to a method of generating positron emission tomography (PET) images from magnetic resonance imaging (MRI), the method comprising: obtaining a MR image from a subject; and applying the model trained according to claim 1 to the MR image. In some aspects, the MR image comprises at least one MR T1 image or at least one MR T2 image. In some aspects, the subject is a low-dose subject and the MR image is converted to a higher quality PET image than true PET.

Furthermore, in one aspect, the present disclosure generally relates to a computer-implemented method of training a model to generate positron emission tomography (PET) images from multimodal input images, the method comprising: selecting a healthy dataset, the healthy dataset including paired PET and multimodal images from healthy subjects; selecting a target dataset, the target dataset including paired PET and multimodal images from subjects having a condition corresponding to a biomarker of interest; creating a training dataset from the combination of healthy dataset and the target dataset; training a machine learning model using the training dataset. In some aspects, the multimodal input images comprise anatomical imaging modalities and/or functional imaging modalities. In some aspects, the multimodal input images are selected from at least two imaging modalities selected from the group consisting of magnetic resonance imaging (MRI), PET, CT, SPECT, EEG/MEG data, and NIRS/fNIRS imaging. In some aspects, the MR images comprise at least one MR sequence image. In some aspects, the MR sequence image comprises an MR T1 image, or MR T2 image, or a combination of images acquired using more than one MR sequences. In some aspects, the biomarker of interest is a synaptic density tracer. In some aspects, the biomarker of interest is synaptic vesicle protein 2A (SV2A). In some aspects, the condition is a brain disorder. In some aspects, the brain disorder a neuropsychiatric disorder. In some aspects, the neuropsychiatric disorder is selected from the group consisting of Alzheimer's disease, mild cognitive impairment, major depressive disorder, schizophrenia, post-traumatic stress disorder, autism spectrum disorders, anxiety disorders, bipolar disorder and substance use disorders. In some aspects, the substance use disorder is cannabis use disorder. In some aspects, the machine learning model comprises a deep learning model. In some aspects, the deep learning model comprises a multi-stage U-net with 3D convolutional layers. In some aspects, the deep learning model comprises a cross-stage feature fusion (CSFF) strategy. In some aspects, the deep learning model comprises a supervised attention module (SAM). In some aspects, the machine learning model comprises a deep convolution neural network or other networks such as a diffusion network. In some aspects, the training comprises patch-based training. In some aspects, the patch-based training comprises extracting at least four random patches for each epoch from each training image.

### BRIEF DESCRIPTION OF THE DRAWINGS

FIG. 1 shows representative predicted results of a healthy control subject. The top row of FIG. 1 presents an MR T1-weighted brain image. The second row of FIG. 1 presents the ground truth image, i.e., the real SV2A brain PET scan. The third row of FIG. 1 presents a synthetic SV2A PET image, generated by the methods as described herein. The fourth and last row of FIG. 1 presents the absolute difference between the real and the synthetic image.

FIG. 2 shows representative predicted results of a cannabis use disorder subject. The top row of FIG. 2 presents an MR T1-weighted brain image. The second row of FIG. 2 presents the ground truth image, i.e., the real SV2A brain PET scan. The third row of FIG. 2 presents a synthetic SV2A PET image, generated by the methods as described herein. The fourth and last row of FIG. 2 presents the absolute difference between the real and the synthetic image.

FIG. 3 shows representative predicted results of a schizophrenia subject. The top row of FIG. 3 presents an MR T1-weighted brain image. The second row of FIG. 3 presents the ground truth image, i.e., the real SV2A brain PET scan. The third row of FIG. 3 presents a synthetic SV2A PET image, generated by the methods as described herein. The fourth and last row of FIG. 3 presents the absolute difference between the real and the synthetic image.

FIG. 4 shows graphical representations of predicted results of 4 health control subjects. In particular FIG. 4 presents the log-scaled joint histograms between predicted images and the ground truth images for the diagnosis group.

FIG. 5 shows graphical representations of predicted results of 4 cannabis use disorder subjects. In particular FIG. 5 presents the log-scaled joint histograms between predicted images and the ground truth images for the diagnosis group.

FIG. 6 shows graphical representations of predicted results of 4 schizophrenia subjects. In particular FIG. 6 presents the log-scaled joint histograms between predicted images and the ground truth images for the diagnosis group.

FIG. 7 shows a schematic representation of an example of an MS U-net architecture.

FIG. 8 shows U-net and MS U-net prediction performance. Inset A presents generation from MRI; Inset B present generation from FDG PET; and Inset C presents generation from both MRI and FDG PET.

FIG. 9 shows a graphical representation of mean and standard deviation of percentage bias for different ROIs across all participants (n=54).

FIG. 10 shows log-scaled joint histograms showing the correlation of the voxels between the predicted [¹¹C]UCB-J PET images and the ground truth for all implemented models.

FIG. 11 shows graphical representations of the comparison of generated image profiles between all six models. The solid blue line represents the ground truth.

### DETAILED DESCRIPTION OF THE INVENTION

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

Unless otherwise required by context, singular terms shall include pluralities and plural terms shall include the singular. The use of “or” means “and/or” unless stated otherwise. The use of the term “including,” as well as other forms, such as “includes” and “included,” is not limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

In this disclosure, “comprises,” “comprising,” “containing” and “having” and the like can have the meaning ascribed to them in U.S. patent law and can mean “includes,” “including,” and the like; “consisting essentially of” or “consists essentially” likewise has the meaning ascribed in U.S. patent law and the term is open-ended, allowing for the presence of more than that which is recited so long as basic or novel characteristics of that which is recited is not changed by the presence of more than that which is recited, but excludes prior art embodiments.

The terms “patient”, “subject”, and “individual” are used interchangeably and are intended to include living organisms, e.g., mammal, that may be subjected to treatment for a given disease. A “subject”, “patient”, or “individual”, as used herein, can be a human or non-human mammal. Non-human mammals include, for example, livestock and pets, such as ovine, bovine, porcine, canine, feline and murine mammals, as well as simian and non-human primate mammals. Preferably, the subject is human.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Detailed Description

Provided herein are methods of generating positron emission tomography (PET) images from magnetic resonance imaging (MRI) data. In one aspect, the present disclosure generally relates to a computer-implemented method of training a model to generate PET images from MRI data/images, the method comprising: selecting a healthy dataset, the healthy dataset including paired MR and PET data/images from healthy subjects; selecting a target dataset, the target dataset including MR and PET data/images from subjects having a condition corresponding to a biomarker of interest; creating a training dataset from the combination of healthy dataset and the target dataset; and training a machine learning model using the training dataset.

In some aspects, the MR images comprise any type of MR image. In some aspects, the MR images comprise at least one MR sequence image. In some aspects, the MR sequence image comprises an MR T1 image, an MR T2 image, or a combination of images acquired using more than one MR sequence. In some aspects, the MR images are derived from structural MRI. In some aspects, the PET images comprise at least one reference region. For instance, the PET images can comprise at least one reference region from a subject. For example, in some aspects, the at least one reference region is a cerebellum of the subject.

In some aspects, the biomarker of interest comprises a biomarker of interest associated with a function, disease or disorder. In some aspects, the biomarker comprises an imaging biomarker. In some aspects, the biomarker comprises a composite biomarker, i.e., an imaging biomarker plus other measurements. In some aspects, the biomarker of interest comprises a biomarker of interest associated with a neuropsychiatric disorder or a neurodegenerative disease. In some aspects, the biomarker of interest comprises a biomarker of interest associated with multiple sclerosis. In some aspects, the biomarker of interest comprises a biomarker of interest associated with a brain disorder. In some aspects, the biomarker of interest is a synaptic density tracer, such as, but not limited to, synaptic vesicle protein 2A (SV2A). In some aspects, the biomarker of interest comprises a biomarker of interest associated with Alzheimer's disease, Huntington's disease, stroke, autism, major depressive disorder, schizophrenia, or substance use disorders. In some aspects, a tracer is used in detection of a biomarker of interest. In some aspects, the tracer is [¹¹C]UCB-J, [¹⁸F]Syn VesT-1, [¹⁸F]Syn VesT-2, and/or [¹⁸F]SDM-16.

In some aspects, the condition is a neuropsychiatric disorder or a neurodegenerative disease. In some aspects, the condition is multiple sclerosis. In some aspects, the condition is a brain disorder. In some aspects, the brain disorder is a neuropsychiatric disorder. In some aspects, the neuropsychiatric disorder includes Alzheimer's disease, mild cognitive impairment, major depressive disorder, schizophrenia, post-traumatic stress disorder, autism spectrum disorders, anxiety disorders, bipolar disorder, and/or substance use disorders. In some aspects, the substance use disorder is cannabis use disorder or alcohol use disorder or cocaine use disorder. In some aspects, the substance use disorder is cannabis use disorder.

In some aspects, the condition is any of the disorders discussed in the Diagnostic and Statistical Manual (DSM-5), which is hereby incorporated by reference in its entirety. For instance, SV2A PET imaging studies have shown abnormalities in schizophrenia, depressive disorder, cannabis use disorder, cocaine use disorder. Alzheimer's disease; Autism spectrum disorder; Depression; Epilepsy; Huntington's disease; Multiple sclerosis; PET; Parkinson's disease; and Stroke. See, for instance, Cai, Z., et al. “PET imaging of synaptic density: A new tool for investigation of neuropsychiatric diseases.” Neuroscience letters vol. 691 (2019): 44-50; and Toyonaga, T., et al. “PET Imaging of Synaptic Density: Challenges and Opportunities of Synaptic Vesicle Glycoprotein 2A PET in Small Animal Imaging.” Frontiers in neuroscience vol. 16 787404. 8 Mar. 2022, the disclosures of each of which are hereby incorporated by reference in their entireties. Regarding the disorder, for example, in some aspects, the disorder is selected from any of the 20 main groups of disorders or the more than 300 different diagnostic categories discussed by the DSM-5. For example, in some aspects, the disorders include, but are not limited to, Attention-Deficit/Hyperactivity Disorder (ADHD), Autism Spectrum Disorder, Conduct Disorder, Disruptive Mood Dysregulation Disorder, Eating Disorders, Gender Dysphoria, Intellectual Disability, Internet Gaming Disorder, Major Depressive Disorder and the Bereavement Exclusion, Mild Neurocognitive Disorder, Obsessive-Compulsive and Related Disorders, Paraphilic Disorders, Personality Disorder, Posttraumatic Stress Disorder, Schizophrenia, Sleep-Wake Disorders, Specific Learning Disorder, Social Communication Disorder, Somatic Symptom Disorder, and Substance-Related and Addictive Disorders.

In some aspects, the machine learning model comprises a deep learning model. In some aspects, the deep learning model comprises an encoder-decoder with 3D convolution layers with Rectified Linear Unit (ReLU) activation operators. In some aspects, the machine learning model comprises a deep convolution neural network or other networks such as a diffusion network. Although described herein primarily with respect to a deep convolution neural network or a diffusion network, as will be appreciated by those skilled in the art, the disclosure is not so limited and may include any other suitable machine learning-based method. In some aspects, the deep learning model comprises a multi-stage (MS) U-net with 3D convolutional layers. In some aspects, the architecture comprises two stages. In some aspects, each stage comprises a U-net structure with skip connections. In some aspects, 7 residual blocks (RB) with residual connections and 6 3D convolutional layers with 3×3×3 kernels to up- or down-sample the imaging data in each stage are used. In some aspects, the residual block comprises two 3×3×3 convolution layers. In some aspects, a leaky ReLu is applied after convolution operations. In some aspects, a 1×1×1 convolution is applied to the RB input before forming the residual connection. In some aspects, the deep learning model comprises a cross-stage feature fusion (CSFF) strategy. In some aspects, the CSFF is applied between the two stages. In some aspects, the CSFF mitigates information loss and/or stabilizes optimization. In some aspects, the deep learning model comprises a supervised attention module (SAM). In some aspects, the SAM is used between the two stages. In some aspects, a CSFF and an SAM are used between the two stages. In some aspects, the SAM generates a residual image with 1×1×1 convolution. In some aspects, the residual image is added to the input image and compared with the ground truth image. In some aspects, attention maps are generated using 1×1×1 convolution and a sigmoid activation. In some aspects, the generated attention maps are concatenated with the residual image and subsequently added to the identity mapping path. In some aspects, the SAM proves ground truth supervision at the first stage. In some aspects, the machine learning model comprises a deep convolution neural network or other networks such as a diffusion network.

In some aspects, the machine learning model comprises a network model trained using: a. MR T1 or T2 to BP 60 PET image (binding potential image derived from 60 mins data); b. MR T1 or T2 to BP 90 PET image (binding potential image derived from 90 mins data); c. MR T1 or T2 to distribution volume ratio (DVR) PET image; or d. MR T1 or T2 to SUV PET image. In some aspects, the training comprises patch-based training. In some aspects, the patch-based training comprises extracting at least four random patches for each epoch from each training image. In some aspects, additional information regarding the subject, such as but not limited to their age, disease, disease state, height, weight, can be included as a part of the input for training. In some aspects, the patch-based training comprises extracting at least four random patches for each epoch from each training image. In some aspects, the training data were cropped randomly into patches of size 64×64×64. In some aspects, the patch size is selected to strike a balance, ensuring it is large enough for the models to capture patterns effectively while maintaining computational efficiency. In some aspects, the batch size is set to 4. In some aspects, 200 epochs are run to achieve the convergence of the cost function. In some aspects, 10-fold cross-validation are conducted to evaluate the model performance using (1) MRI, (2) [¹⁸F]FDG PET, and (3) both MR and FDG as input. In some aspects, in the case of (3), the two input modalities are concatenated in the channel dimension.

In some aspects, low-dose subjects are excluded from the training dataset. In some aspects, low-dose subjects comprise subjects exposed to about 3 to about 5 mCi. In some aspects, low-dose subjects comprise subjects exposed to less than 5, less than 4, less than 3, less than 2, or less than 1 mCi. In some aspects, low-dose subjects comprise subjects exposed to less than 5 mCi.

In some aspects, the MR and PET images are subjected to preprocessing prior to training the machine learning model. In some aspects, the preprocessing comprises segmentation and co-registration of the MR and PET images. In some aspects, the preprocessing comprises generating a standardized voxel size. In some aspects, the preprocessing comprises motion correction, denoising, regional parcellation, segmentation, and/or normalization. In some aspects, the preprocessing comprises spatial adaptive non-local denoising, bias-field correction, regional parcellation, and/or refined locally-adaptive segmentation.

Furthermore, in one aspect, the present disclosure generally relates to a method of generating positron emission tomography (PET) images from magnetic resonance imaging (MRI), the method comprising: obtaining a MR image from a subject; and applying the model trained as described herein to the MR image. In some aspects, the MR image comprises at least one MR T1 image or at least one MR T2 image. In some aspects, the subject is a low-dose subject and the MR image is converted to a higher quality PET image than true PET.

Without wishing to be bound by theory, the methods disclosed herein are believed to be the first successful conversion of MRI images/data to SV2A PET images. This conversion of MRI images/data to SV2A PET images also provides the ability to derive molecular information (e.g., SV2A level) from MRI scans. Furthermore, due to the lower cost of MRI as compared to PET imaging, the methods disclosed herein reduces the cost and increases the accessibility of PET data. Moreover, the methods described herein can in some instances allow for PET image generation for pregnant women and/or adolescents, as both groups are not allowed to undergo PET imaging due to radiation concerns. Furthermore, such methods as those described herein can lower the total radiation exposure and enable serial monitoring of response to treatment, as undergoing multiple PET scans to monitor disease progression can be burdensome for patients, and also is limited by the amount of radiation exposure that is allowed for a patient. In some aspects, when using an MRI imaging modality, the risk of radiation exposure can be eliminated. As such, the methods disclosed herein represent an early and affordable tool in the diagnosis and/or treatment of various neuropsychiatric disorders and/or neurodegenerative diseases.

Moreover, in some aspects, the methods disclosed herein include generating PET images from multimodal input images. In such aspects, the method comprises selecting a healthy dataset, the healthy dataset including paired PET and multimodal images from healthy subjects; selecting a target dataset, the target dataset including paired PET and multimodal images from subjects having a condition corresponding to a biomarker of interest; creating a training dataset from the combination of healthy dataset and the target dataset; and training a machine learning model using the training dataset. As used herein, the term “multimodal input images” refers to input images from at least two different modalities, types of images, or acquisition sequences. The multimodal input images may be in addition or alternatively to the MRI images/data discussed above. In some aspects, the multi-modal images comprise anatomical and/or functional imaging modalities. For example, in some aspects, anatomical imaging modalities include, but are not limited to, magnetic resonance imaging (MRI) and related techniques/sequences such as diffusion weighted imaging (DWI), susceptibility weighted imaging (SWI), diffusion tensor imaging (DTI), neurite orientation dispersion and density imaging (NODDI), computed tomography (CT), and/or Near-infrared spectroscopy (NIRS). In some aspects, functional imagining modalities include, but are not limited to, positron emission tomography (PET), single photon emission computed tomography (SPECT), magnetic resonance spectroscopy (MRS), functional MRI (fMRI) including resting-state and task-based fMRI, electroencephalography (EEG), magnetic encephalography (MEG), and/or functional Near-infrared spectroscopy (fNIRS). In some aspects, the multimodal input images are selected from at least two of magnetic resonance imaging (MRI) images, PET images of a tracer (e.g. [¹⁸F]FDG) that is different from the target PET tracer of SV2A, CT images, DTI, NODDI, MRS, SPECT, EEG, and NIRS/fNIRS. It is noted that, though discussed primarily with respect to generating SV2A PET images, the disclosure is not so limited and expressly includes generating any other suitable PET images from the one or more input images. Other suitable output images include, but are not limited to, neuroreceptor PET mapping brain receptors such as dopamine, serotonin, glutamate, GABA and/or molecular targeted PET mapping molecular targets such as tau and/or amyloid.

In some aspects, the selecting of the dataset includes generating the MRI images. For example, generating of the images may include collecting T1-weighted MRI images on an imaging systems using standard magnetization-prepared rapid-acquisition gradient-echo (MP-RAGE) sequences. In some aspects, each participant's PET images are co-registered to the T1w MRI and masked to include voxels contained in skull-stripped T1-weighted image. In some aspects, the T1w images are also used to define the ROIs.

In some aspects, the selecting of the dataset includes generating the [¹⁸F]FDG and [¹¹C]UCB-J images. For example, the generating of the images may include collecting dynamic PET data, such as by using a high-resolution research tomograph (HRRT) system. In some aspects, PET listmode data are reconstructed into volumes of 256×256×207 with a voxel size of 1.219×1.219×1.231 mm³ with normalization and corrections for attenuation, scatters, randoms, deadtime, and motion using a list-mode reconstruction platform (see, for instance, R. E. Carson, et al., 2003 IEEE Nuclear Science Symposium. Conference Record (IEEE Cat. No.03CH37515), pp. 3281-3285, 2004). In some aspects, parametric images of [¹¹C]UCB-J non-displaceable binding potential (BPND) are estimated using simplified reference tissue model-2 step (SRTM2) with the centrum semiovale (CS) as the reference region. In some aspects, for [¹¹C]UCB-J PET scans, the parametric images of distribution volume ratio (DVR) are generated with the cerebellum (Cb) as the reference region, calculated as DVR=(BPND+1)/(BPND[Cb]+1). In some aspects, for [¹⁸F]FDG PET scans, standard uptake value (SUV) images are generated from data of about 60 to about 90 min.

Those skilled in the art will recognize, or be able to ascertain using no more than routine experimentation, numerous equivalents to the specific procedures, embodiments, claims, and examples described herein. Such equivalents are considered to be within the scope of this invention and covered by the claims appended hereto.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

### Example 1

### Introduction

Positron Emission Tomography (PET) can provide molecular information about the brain. [¹¹C]-UCB-J (app311) is a PET tracer for imaging the synaptic vesicle protein 2A (SV2A) in the human brain, and SV2A is a biomarker in the early diagnosis of brain disorders, including Alzheimer's disease, major depressive disorder, schizophrenia, and substance use disorders. However, the use and accessibility of PET imaging using SV2A tracer is limited due to its cost, need for specialized scanners, and the required level of expertise to perform the imaging and analysis. Furthermore, the use of radioactive isotopes also limits use of the technique in vulnerable populations. As such, the present example describes methods for generating synthetic SV2A PET images from another common brain imaging technique: Magnetic Resonance Imaging (MRI). MRI can show soft tissue contrast and metabolism indication without using any damaging ionizing radiation.

### Materials and Methods

In the present example, a deep convolutional neural network was implemented to predict [¹¹C]-UCB-J PET images of synaptic vesicle protein 2A (SV2A), a surrogate of synaptic density, from MR T1 data. Dynamic [¹¹C]-UCB-J and MRI scans were performed in 139 participants, including 20 participants with cannabis use disorder (CU) and 26 participants with schizophrenia (SZ) and remaining participants are healthy controls (HC). Cerebellum was used as the reference region for the PET images. For the [¹¹C]-UCB-J image prediction, 3 network models were trained and tested, which included 1) MR T1 to BP 60, 2) MR T1 to BP 90, 3) MR T1 to distribution volume ratio (DVR). The normalized root mean square error (NRMSE), structure similarity index (SSIM), peak signal-to-noise ratio (PSNR) and Pearson's correlation coefficient were calculated for evaluating the image prediction accuracy. Mean bias of various ROIs in the brain and correlation plots between predicted images and true images were calculated for ROI-based prediction accuracy.

Further details of the materials and methods are provided below.

### A. Human Study Dataset and Brain Imaging

### 1. PET Dataset

Mixed diagnosis, race and sex, age from 19 to 83;
[¹¹C]-UCB-J Injection Activity, mean (SD): 15.03 (4.84);
Acquired on an HRRT system (Siemens/CTI, Knoxville, TN, USA) in list mode at Yale PET center;
Image size 256×256×207, voxel size 1.219×1.219×1.231 mm³;
Parametric images of [¹¹C]-UCB-J non-displaceable binding potential (BP_{ND}) were estimated, distribution volume ratio DVR=(BP_{ND}+1)/(BP_{ND}[cerebellum]+1).

### 2. MR Dataset

Mixed diagnosis, race and sex, age from 19 to 83, the same groups of subjects in the PET dataset;
MR T1-weighted image collected on Siemens 3T MAGNETOM imaging systems using standard gradient-echo sequences;
ROIs were derived from the MR images using SPM aal3;

### 3. Preprocessing Method

Whole-head T1-weigthed images were processed using the Computational Anatomy Toolbox 12 (spatial adaptive non-local denoising, bias-field correction, regional parcellation, refined locally-adaptive segmentation);
Estimated gray-matter, white-matter, and CSF tissue segments were combined to generate a skull-stripped, intensity-normalized T1 image in participant native space
Resliced to the voxel dimensions of the PET images (1.219×1.219×1.231 mm³)

### B. Deep Learning Model Architecture

An encoder-decoder with 3D Convolutional layers with ReLU activation operations.
An increasing number of filters are used in the upsampling layers and a decreasing number of filters are used in the downsampling layers.
L2 Loss.
Adam optimizer.
MR T1 images are used as the input data for the networks and SV2A PET images are the target outputs.

### C. Experimental Setup

Train the model on paired MR and PET images acquired from both healthy people and patients (sz and cu).
Train and test subjects are randomly selected from norm dose SZ, CU and HC groups to form sets with similar ratio.
Low-dose subjects are used in the testing dataset and excluded from training.
Train-validate-test split: 139 subjects in total, 109 training subject, 12 validation subjects, 18 test subjects (including 5 low dose subjects).
Cross validation to test all the subjects.
Patch-based training, for each epoch extract 4 random patches from each training image, to increase training samples and save memory during training, patch size 64×64×64.
Trained on servers at Yale PET Center, GPU NVIDIA A40.

### D. Statistical Analysis

MSE/RMSE/NRMSE—mean squared error/root mean squared error/normalized root mean square error

$$MSE = \frac{1}{n} {\sum }_{n}^{i = 1} {‖ {I}_{x} - {I}_{y} ‖}^{2} \\ RMSE = \frac{{‖ {I}_{x} - {I}_{y} ‖}^{2}}{{‖ {I}_{x} ‖}_{2}^{2}} \\ NRMSE = \frac{{‖ {I}_{x} - {I}_{y} ‖}^{2}}{{‖ {I}_{x} ‖}_{2}^{2} ( {I}_{{x}_{max}} - {I}_{{x}_{min}} )}$$

where I_{y} is the predicted image from the MR T1-weighted image and Iₓ is the true image.
SSIM Structural Similarity Index

$$SSIM = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$

where μₓ and μ_{y} indicate the mean of the real and predicted PET SV2A image, σₓ and σ_{y} are the standard deviation of the real and predicted volume and σ_{xy} represents the covariance of the real and predicted volume. c₁ and c₂ are regularization constants chosen proportional to the dynamic range of the voxel values of the images to avoid numerical instability for image regions where the local mean or standard deviation is close to zero.
PSNR peak signal-to-noise ratio

$$PSNR = 10 \cdot log 10 \frac{{MAX}^{2}}{{‖ {I}_{x} - {I}_{y} ‖}_{2}^{2}}$$

where MAX is the maximum possible voxel value of the image, I_{y} and Iₓ are the predicted and the true PET SV2A image.
Bias

$$Bias = \frac{{μ}_{{x}_{ROI}} - {μ}_{{y}_{ROI}}}{{μ}_{{x}_{ROI}}}$$

where μₓ_{_{ROI}} and μ_{y}_{_{ROI}} denote the mean voxel values within a certain region of interest (ROI).
Pearson's correlation

$$ρ = \frac{Cov ( {I}_{x} , {I}_{y} )}{{σ}_{x} {σ}_{y}}$$

### Results

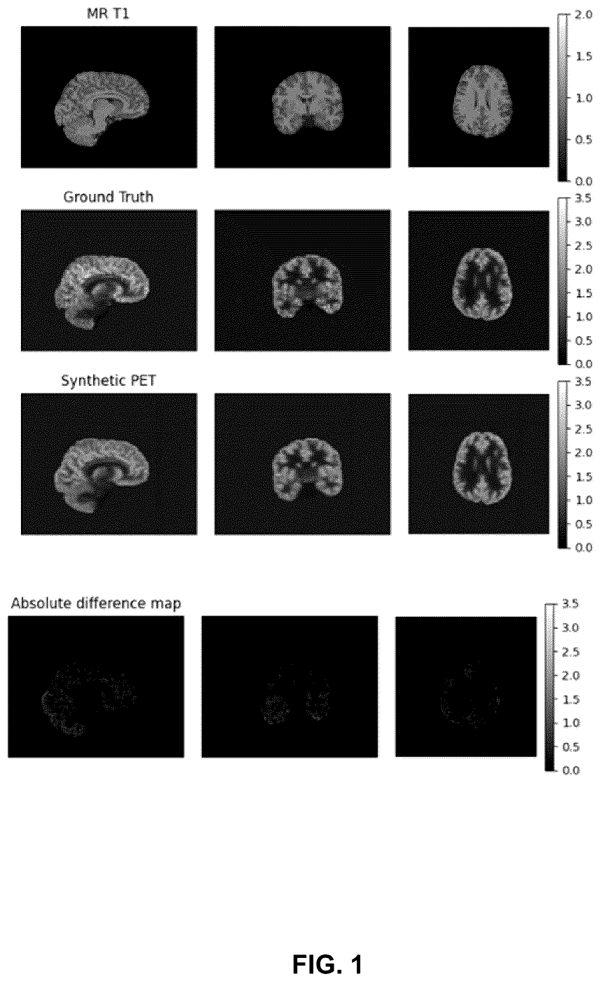

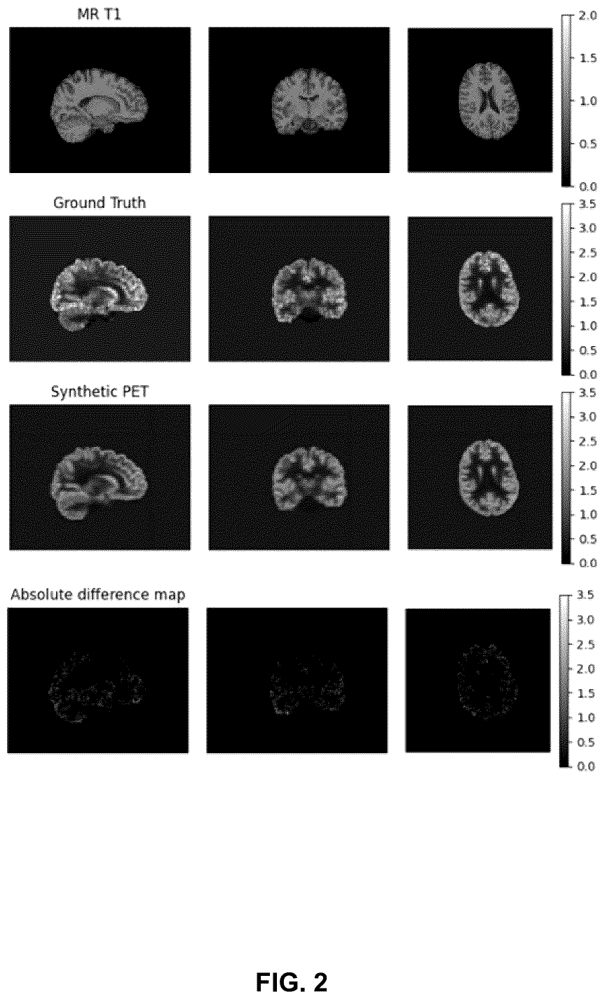

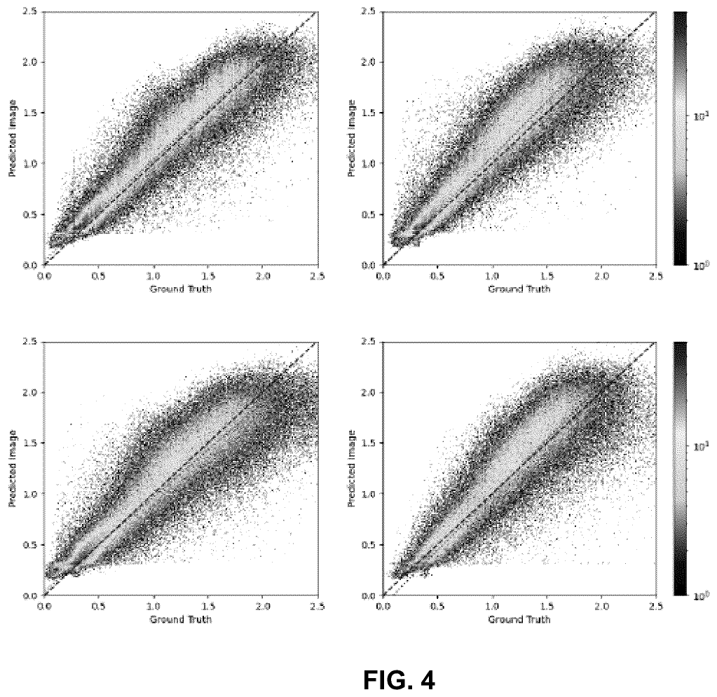

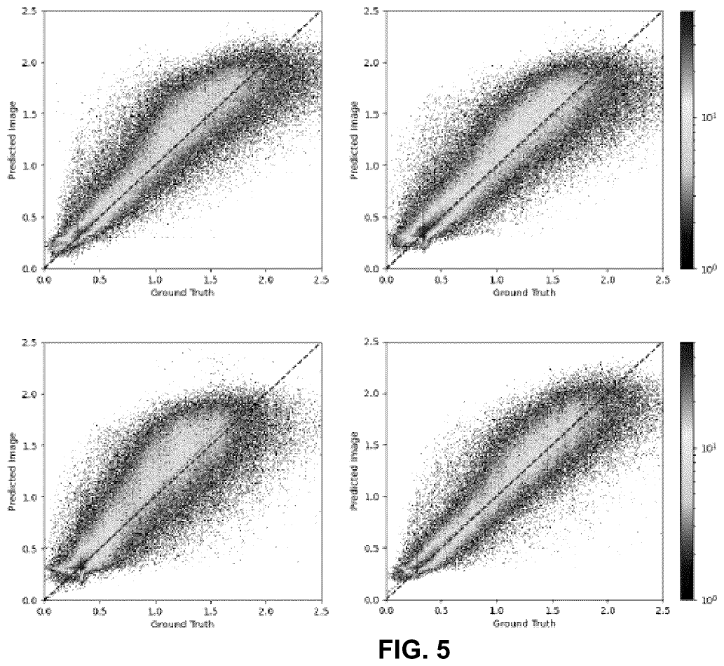

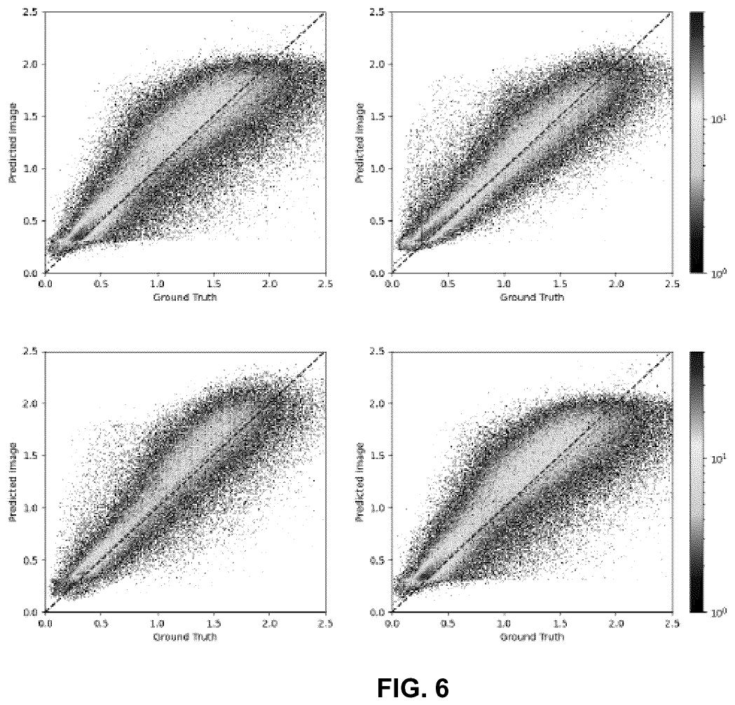

The results showed that our network models obtained satisfactory [¹¹C]-UCB-J static and parametric images (FIG. 1-FIG. 6). The achieved evaluation metrics are shown in TABLE 1 below. Additionally, the encoder-decoder networks and generative adversarial networks (GANs) accelerated the use of deep learning in the image-to-image translation domain and image restoration.

TABLE 1
model performance

| | BIAS | MSE | RMSE | NRMSE | PSNR | SSIM |
|---|---|---|---|---|---|---|
| Mean | −1.38% | 0.0067 | 0.0784 | 0.2219 | 70.5022 | 0.8899 |
| Standard | 11.49% | 0.0065 | 0.0234 | 0.0607 | 1.9582 | 0.0501 |
| Deviation | | | | | | |

Further details concerning the results are presented below.

### III. Results

### 1. Qualitative Result

The synthetic PET image closely resembled the true image in terms of resolution, contrast, and tracer distribution. The synthetic PET image exhibited lower noise levels but was smoother than the real images. Visually, the proposed model demonstrated superior performance in synthesizing PET images from their corresponding MRI slices. The model accurately captured intricate brain features.

### 2. Qualitative Result

Overall image quality evaluation

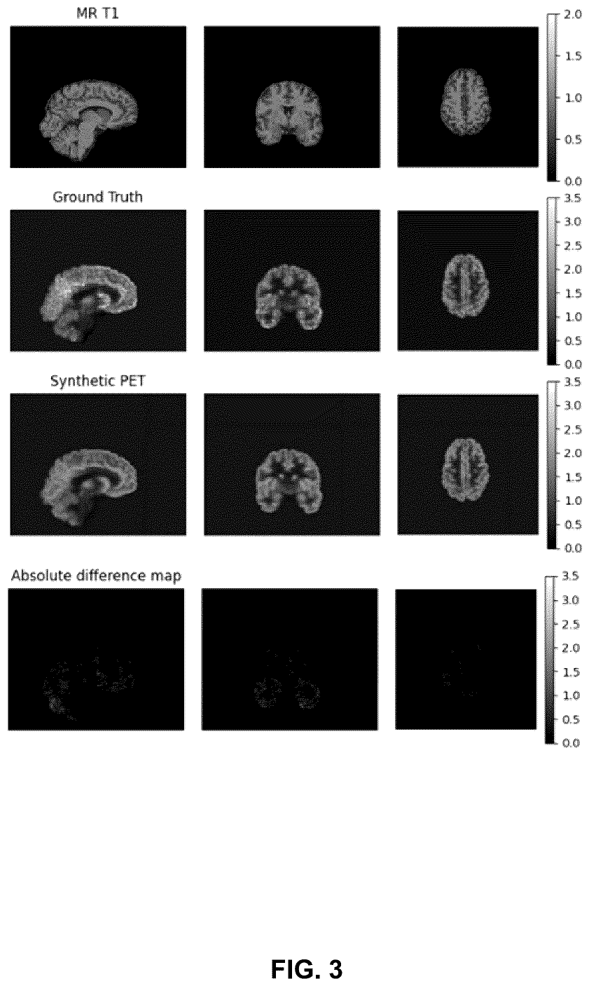

Quantitative results were consistent with the visual qualitative observation and shown in Table 1. Our method simultaneously achieved a high PSNR, low MSE and high SSIM. The mean MSE of the network performance was 0.0067 for all test subjects, 0.0077 for the SZ group, 0.0057 for the CU group and 0.0066 for the HC group. The mean SSIM was 0.8899 for all test subjects, 0.8861 for the SZ group, 0.8907 for the CU group and 0.8909 for the HC group, showing the perceived change in structural information between the synthetic and gold standard images was small. The mean PSNR was 70.5022 for all, 69.6746 for the SZ group, 70.8913 for the CU group and 70.6583 for the HC group. The high PSNR indicated good image quality. The mean percentage bias across all ROIs was −1.38% for all test subjects, 1.53% for the SZ group, −2.13% for the CU group and −2.06% for the HC group. For the low-dose subjects, the network achieved a MSE of 0.0124, a SSIM of 0.7966 and a PSNR of 67.3788. Consistency analysis of histogram distribution was performed between the true [¹¹C]-UCB-J PET image and the predicted [¹¹C]-UCB-J PET image. The correlation plot between the predicted image voxel values and true image voxel values with linear fitting is shown in FIGS. 3-5. The average Pearson's correlation was 0.9575 for all normal-dose subjects, 0.9473 for the SZ group, 0.9619 for the CU group and 0.9596 for the HC group, and 0.9065 for all low-dose subjects. The numerical results indicated that the predicted synthetic PET can achieve low absolute deviation
ROI evaluation

ROI bias between true and predicted images

Average overall percentage bias for all subjects and for different groups ROI comparison for all subjects and for different groups

Statistical tests across different diagnostic groups—for certain ROIs there are difference between the predicted and true images and for certain ROIs there are difference between groups

The mean percentage bias and standard deviation of all the selected ROIs are shown in Table 2. The mean bias was under 5% for most ROIs. The high standard deviation in ROI bias might be attributed to the variability in tracer uptake among subjects. Consistency analysis of histogram distribution for each ROI was also performed between the true [¹¹C]-UCB-J PET image and the predicted [¹¹C]-UCB-J PET image.

TABLE 2
10-fold cross validation ROI evaluation results

| | | | | | | | | | | | Ant. |
|---|---|---|---|---|---|---|---|---|---|---|---|
| | Frontal | Insula | Hippocampus | Amygdala | Occipital | Parietal | Precuneus | Putamen | Pallidum | Temporal | Cingulate |
| Bias | −2.18% ± | −0.25% ± | 2.69% ± | −2.07% ± | −4.41% ± | −5.27% ± | −3.08% ± | −2.81% ± | −2.64% ± | −1.61% ± | −1.22% ± |
| | 8.18% | 8.00% | 9.87% | 9.47% | 8.88% | 7.65% | 8.02% | 9.10% | 9.72% | 7.56% | 8.68% |
| RMSE | 0.2736 | 0.3133 | 0.2651 | 0.3156 | 0.3239 | 0.3185 | 0.2930 | 0.3292 | 0.2464 | 0.3039 | 0.2991 |
| NRMSE | 0.2052 | 0.2131 | 0.2759 | 0.2441 | 0.2398 | 0.2268 | 0.2094 | 0.2145 | 0.2349 | 0.2177 | 0.2092 |
| SSIM | 0.7299 | 0.6011 | 0.5734 | 0.5163 | 0.6513 | 0.6412 | 0.6653 | 0.6092 | 0.7284 | 0.6115 | 0.6959 |
| Corr. | 0.8715 | 0.7151 | 0.7375 | 0.6672 | 0.7872 | 0.8212 | 0.8189 | 0.7954 | 0.7145 | 0.8063 | 0.8316 |

### CONCLUSION

The present example demonstrated the feasibility of generating synthetic [¹¹C]-UCB-J

PET images from MR images with reasonable prediction accuracy. The utilization of 3D convolutional neural networks for cross-modality translation from MRI to PET proved to be a viable approach.

### Example 2

### Materials and Methods

### A. Data Preparation

54 participants (25 M, 29 F; 32 AD, 22 HC) who underwent MRI, [¹¹C]UCB-J PET and [¹⁸F]FDG PET scans were included in this study (A. P. Mecca et al., Alzheimer's & Dementia, vol. 16, no. 7, pp. 974-982, 2020). The datasets were acquired at the Yale MR Research center and the Yale PET center. All participants provided written informed consent, and the research protocols were approved by the Yale Institutional Review Board. The imaging procedure and tracer kinetic modelling have been reported previously (A. P. Mecca et al., Alzheimer's & Dementia, vol. 16, no. 7, pp. 974-982, 2020).

Briefly, [¹⁸F]FDG and [¹¹C]UCB-J was administered as an intravenous bolus injection. The mean injected activity was ˜5 mCi for [¹⁸F]FDG, ˜16 mCi for [¹¹C]UCB-J. Up to 120 minutes of dynamic PET data were acquired on a high-resolution research tomograph (HRRT) system (Siemens/CTI, Knoxville, TN, USA). For the analysis of metabolite, blood sampling was done during the scans using arterial catheters. For attenuation correction, an additional transmission scan was obtained. For motion correction, a Polaris Vicra optical tracking system (NDI Systems, Waterloo, Canada) was employed to measure the head motion. PET listmode data were reconstructed into volumes of 256×256×207 with a voxel size of 1.219×1.219×1.231 mm³ with normalization and corrections for attenuation, scatters, randoms, deadtime, and motion using a list-mode reconstruction platform (R. E. Carson, 2003 IEEE Nuclear Science Symposium. Conference Record (IEEE Cat. No.03CH37515), pp. 3281-3285, 2004).

Parametric images of [¹¹C]UCB-J non-displaceable binding potential (BP_{ND}) were estimated using simplified reference tissue model-2 step (SRTM2) with the centrum semiovale (CS) as the reference region. For [¹¹C]UCB-J PET scans, the parametric images of distribution volume ratio (DVR) were generated with the cerebellum (Cb) as the reference region, calculated as DVR=(BP_{ND}+1)/(BP_{ND}[Cb]+1). For [¹⁸F]FDG PET scans, standard uptake value (SUV) images were generated from 60 to 90 min.

T1-weighted MRI images were collected on a Siemens 3T MAGNETOM imaging systems using standard magnetization-prepared rapid-acquisition gradient-echo (MP-RAGE) sequences. Each participant's PET images were co-registered to the T1w MRI and masked to include voxels contained in skull-stripped T1-weighted image. The T1w images were also used to define the ROIs.

### B. Model Design

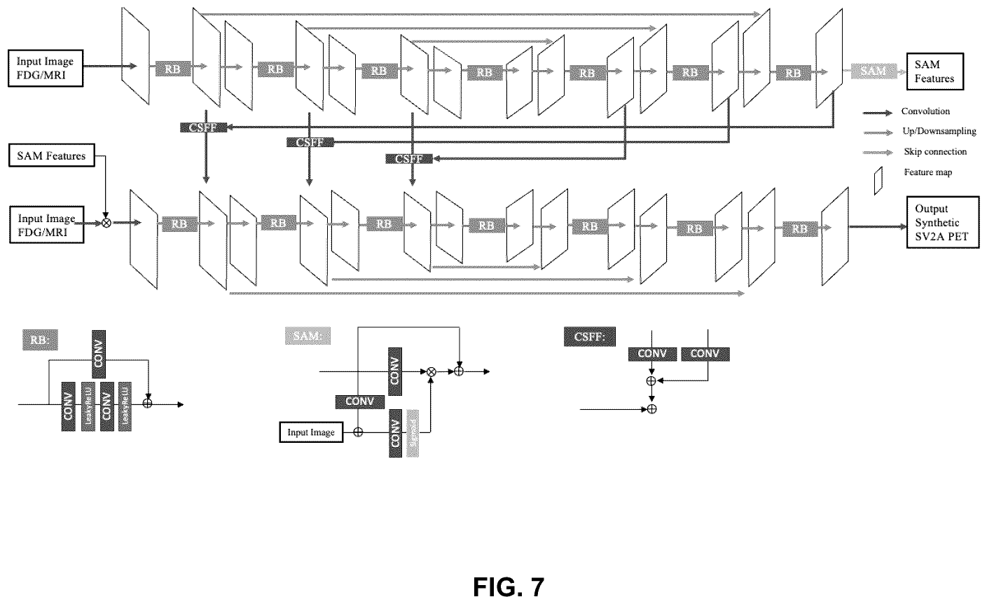

A Multi-stage (MS) U-net with 3D convolutional layers was employed for the synthetic SV2A PET generation task. The multi-stage design decomposes challenging tasks and facilitates progressive learning and was shown to be more effective and stable than their single-stage counterpart for image restoration tasks in prior works (S. W. Zamir et al., 2021 IEEE/CVF Conference on Computer Vision and Pattern Recognition (CVPR), Nashville, TN, USA: IEEE, June 2021, pp. 14816-14826; L. Chen, X. et al., Proceedings of the IEEE/CVF Conference on Computer Vision and Pattern Recognition, 2021, pp. 182-192). Here this design was adopted for image translation, the detailed architecture is illustrated in FIG. 7.

The architecture consisted of two stages, and each stage had a U-net structure with skip connections. There were 7 residual blocks (RB) with residual connections and 6 3D convolutional layers with 3×3×3 kernels to up-or down-sample the imaging data in each stage. Each residual block had two 3×3×3 convolution layers. Leaky ReLu was applied after convolution operations. One 1×1×1 convolution was also applied to the RB input before forming the residual connection.

The cross-stage feature fusion (CSFF) strategy was implemented between the two stages to mitigate information loss and to stabilize optimization: as shown in FIG. 7, features from first stage are refined with 3×3×3 convolutions and passed to the second stage for aggregation to enrich the information received in the next stage and stabilize optimization (S. W. Zamir et al., 2021 IEEE/CVF Conference on Computer Vision and Pattern Recognition (CVPR), Nashville, TN, USA: IEEE, June 2021, pp. 14816-14826).

A supervised attention module (SAM) was also used between the two stages. SAM took the incoming features and generated a residual image with a 1×1×1 convolution. The residual image was added to the input image and compared with the ground truth image. Then the attention maps were generated using a 1×1×1 convolution and a sigmoid activation. The generated attention maps were concatenated with the residual image and subsequently added to the identity mapping path. SAM ensured that only the informative features are propagated to the next stage (S. W. Zamir et al., 2021 IEEE/CVF Conference on Computer Vision and Pattern Recognition (CVPR), Nashville, TN, USA: IEEE, June 2021, pp. 14816-14826). This mechanism also proved ground truth supervision at first stage.

### C. Evaluation Strategies

For evaluation, 18 regions of interest (ROIs) are derived using FreeSurfer based on the T1w MRI. Percentage bias is computed between the predicted voxel values and the ground truth voxel values for the whole image and common ROIs.

Several standard metrics were used to quantitively evaluate the network, including Pearson's correlation ρ, normalized mean square error (NMSE), percentage bias and peak signal-to-noise ratio (PSNR), structural similarity index measure (SSIM):

$$ρ = \frac{Cov ( {I}_{true} , {I}_{pred} )}{{σ}_{true} {σ}_{pred}} , \\ NMSE = {‖ {I}^{pred} - {I}^{true} ‖}_{2}^{2} / {‖ {I}^{true} ‖}_{2}^{2} , \\ percentage bias = \frac{{\sum }_{m ∈ R} {I}_{m}^{pred} - {\sum }_{m ∈ R} {I}_{m}^{true}}{{\sum }_{m ∈ R} {I}_{m}^{pred}} ,$$

where I_{pred} is the prediction and Iₜᵣᵤₑ is the ground truth, R could be the whole image or certain regions of interest (ROIs);

$$PSNR = 10 \cdot log 10 \frac{{MAX}^{2}}{{‖ {I}_{true} - {I}_{pred} ‖}_{2}^{2}} ,$$

where MAX is the maximum possible voxel value of the image;

$$SSIM = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} ,$$

where μₓ, μ_{y} and σₓ, σ_{y} are the mean and standard deviation of the real and predicted volumes, σ_{xy} is the covariance, c₁, c₂ are regularization constants.

### D. Implementation

The training data were cropped randomly into patches of size 64×64×64. Experiments were carried out on an NVIDIA Quadro RTX 8000 GPU. As a common practice, the patch size was selected to strike a balance, ensuring it was large enough for the models to capture patterns effectively while maintaining computational efficiency. The batch size was set to 4, and 200 epochs were run to achieve the convergence of the cost function. 10-fold cross-validation were conducted to evaluate the model performance using (1) MRI, (2) [¹⁸F]FDG PET, and (3) both MR and FDG as input. In the case of (3), the two input modalities were concatenated in the channel dimension.

The MS U-net's prediction results were further evaluated by implementing a 3D U-net as comparison. The U-net was trained with the same datasets and setting. The impact of having only one modality, either MRI T1w or FDG PET data, as input was explored to test its performance. In total 6 models were trained, which models are listed in Table I.

TABLE I
IMPLEMENTED MODELS

| | MODEL | INPUT |
|---|---|---|
| a | 3D U-net | MRI |
| b | 3D MS U-net | MRI |
| c | 3D U-net | FDG |
| d | 3D MS U-net | FDG |
| e | 3D U-net | Both |
| f | 3D MS U-net | Both |

### Results

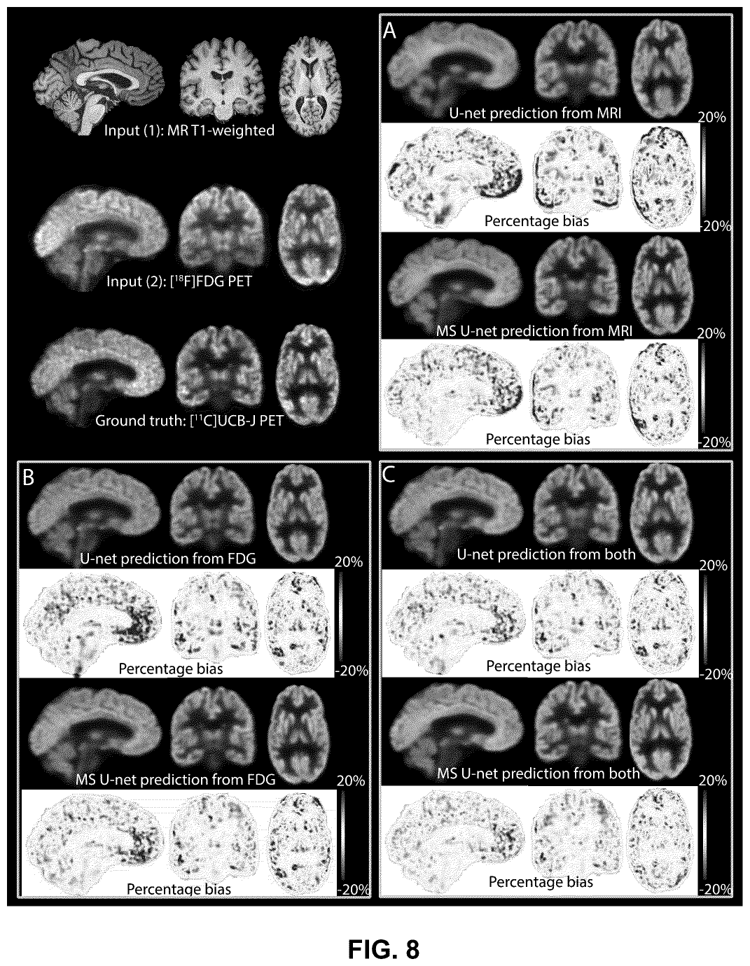

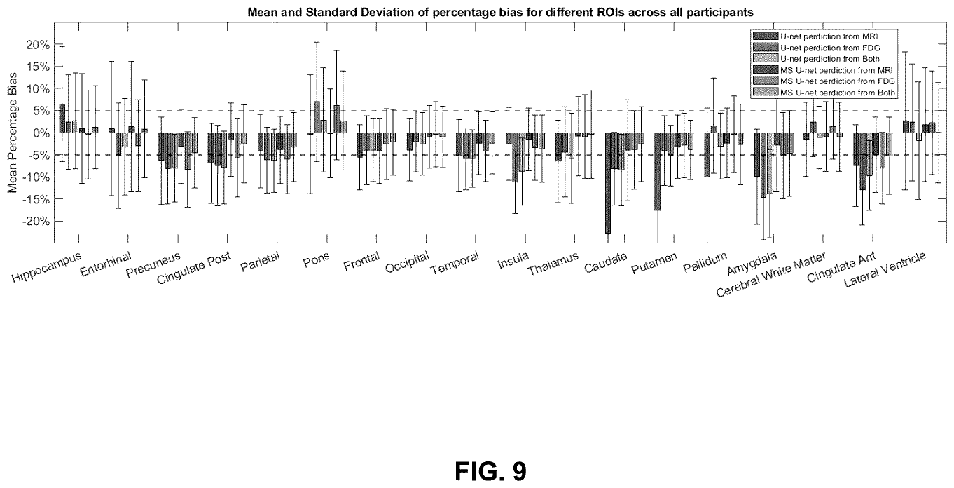

FIG. 8 shows sample synthetic [¹¹C]UCB-J PET images from the networks. The synthetic images were consistent with the ground truth in terms of tracer distribution and contrast. Using a MS U-Net to predict [¹¹C]UCB-J PET images from both the MRI and [¹⁸F]FDG PET was the most accurate. The whole image bias was under 3%, the mean SSIM was around 0.89 and the average pearson's correlation between the predicted voxels and the ground truth voxels across all subjects was around 0.98. As shown in Table II, the quantitative evaluations were consistent with the visual observation: the MS U-net achieved less bias in certain regions (e.g., outer rim of cortex) and outperformed U-net. Furthermore, based on the ROI analysis results in FIG. 9, MS U-net was able to attain below 5% mean bias across all participants for all ROIs except cingulate anterior cortex, which had a bias of −5.25%, if having both MRI and FDG PET. Such a multi-stage architecture progressively learned the features and was shown to be more efficient.

TABLE II
MODEL PERFORMANCE

| INPUT | MODEL | BIAS↓ | NMSE↓ | PSNR↑ | SSIM↑ | CORR↑ |
|---|---|---|---|---|---|---|
| (1) | U-net | −3.337% ± | 0.06004 ± | 25.7069 ± | 0.8469 ± | 0.9594 ± |
| MRI | | 6.911% | 0.01604 | 1.1536 | 0.0312 | 0.0117 |
| | MS | −2.389% ± | 0.04702 ± | 26.8399 ± | 0.8739 ± | 0.9689 ± |
| | U-net | 6.797% | 0.01634 | 1.2228 | 0.0328 | 0.01×21 |
| (2) | U-net | −2.609%± | 0.04633± | 26.8693 ± | 0.8606 ± | 0.9699 ± |
| FDG | | 7.347% | 0.01439 | 1.2169 | 0.0426 | 0.0106 |
| | MS | −2.980%± | 0.04598 ± | 27.0458 ± | 0.8633 ± | 0.9713 ± |
| | U-net | 9.186% | 0.01994 | 1.5269 | 0.0363 | 0.0109 |
| (3) | U-net | −3.775% ± | 0.03829 ± | 27.6465 ± | 0.8861 ± | 0.9755 ± |
| BOTH | | 6.516% | 0.00926 | 1.0213 | 0.0235 | 0.0073 |
| | MS | −2.059% ± | 0.03576 ± | 27.9643 ± | 0.8941 ± | 0.9774 ± |
| | U-net | 6.913% | 0.00924 | 1.0705 | 0.0225 | 0.0067 |

Meanwhile, it was also found that having [¹⁸F]FDG PET alone as the input generated better visual results than MRI alone, and comparing the performance of different models in Table II, it was observed that for U-Net incorporating both modalities did not always improve the performance, indicating that the channel-wise concatenated imaging data were not learned effectively. On the other hand, the MS U-Net incorporated the two modalities concatenated in the input channels. Having both MR T1-weighted and [¹⁸F]FDG PET images as inputs achieved the best prediction results.

Additionally, 2-sample t-tests were performed, and it was found that the differences between AD patients and healthy participants in certain regions were still significant in the generated images. For example, it was found that for hippocampus, there were significant SV2A reductions (2 sample t-test, n=54, p=0.0000) in AD participants compared to HC participants in their ground truth [¹¹C]UCB-J PET images, which was consistent with previous findings (A. P. Mecca et al., Alzheimer's & Dementia, vol. 16, no. 7, pp. 974-982, 2020). In the generated images from MS U-Net based on both inputs, this significant difference was also found between the two groups (2 sample t-test, n=54, p=0.0001), suggesting that the model was able to learn and reflect the differences in SV2A change due to AD. Table III reports the t-test results for each ROIs. t-tests were also performed on the image generation metrics and ROI percentage biases between healthy participants and AD patients and found no between-group differences in the generation performance of the model. The MS U-net made robust predictions for both healthy participants and AD patients.

TABLE III
P-VALUES OF 2-SAMPLE T-TESTS BETWEEN AD AND HC IN CERTAIN ROI

| | Hippocampus | Entorhinal | Precuneus | Cingulate | Parietal | Pons | Frontal | Occipital | Temporal |
|---|---|---|---|---|---|---|---|---|---|
| Ground | 0.0000 | 0.0000 | 0.0002 | 0.0143 | 0.0002 | 0.4196 | 0.0009 | 0.0358 | 0.0002 |
| truth | | | | | | | | | |
| Perdicted | 0.0001 | 0.0000 | 0.0001 | 0.0015 | 0.0005 | 0.2538 | 0.002 | 0.1114 | 0.0001 |
| image | | | | | | | | | |

| | | | | | | | Cerebral | | |
|---|---|---|---|---|---|---|---|---|---|
| | | | | | | | White | Cingulate | Lateral |
| | Insula | Thalamus | Caudate | Putamen | Pallidum | Amygdala | Matter | Ant | Ventricle |
| Ground | 0.0005 | 0.0086 | 0.1504 | 0.0384 | 0.0054 | 0.0017 | 0.0299 | 0.0069 | 0.1142 |
| truth | | | | | | | | | |
| Perdicted | 0.0014 | 0.0171 | 0.1130 | 0.0713 | 0.0744 | 0.0002 | 0.0014 | 0.0064 | 0.1274 |
| image | | | | | | | | | |

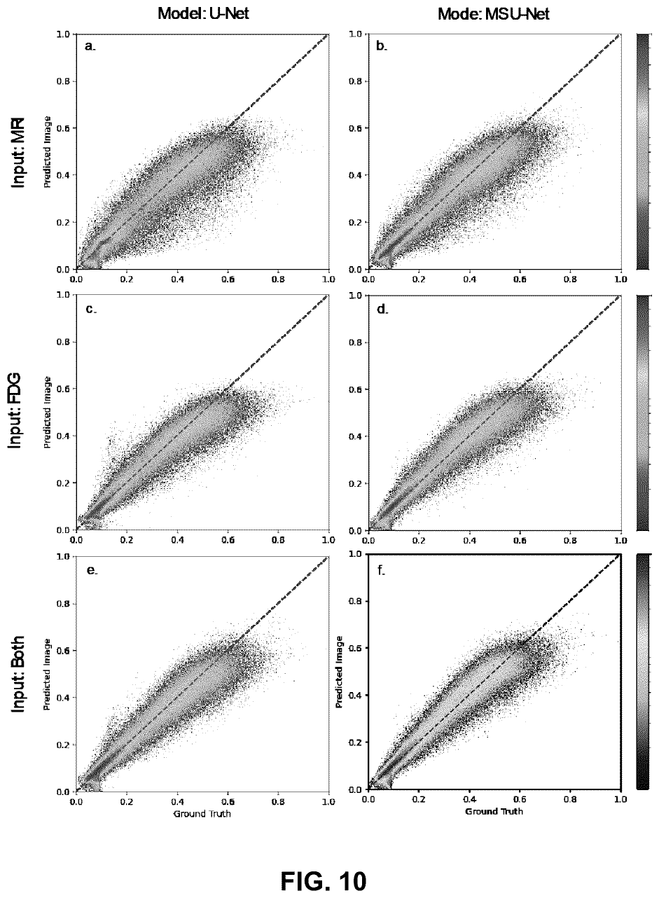

Consistency analysis was performed voxel-by-voxel between the ground truth image and the predicted [¹¹C]UCB-J PET image. The correlation plots between the predicted image voxel values and true image voxel values are shown in FIG. 10. The distributions of the voxels from models trained using only MRI were more scattered. And the distributions of the voxels from U-Nets deviated more from the line of identity compared to those from MS U-Nets. Overall, the voxels predicted from MS U-Net based on both T1w MRI and [¹⁸F]FDG PET were more concentrated and aligned with the line of identity. From Table II we also confirmed that MS U-Net with both T1w MRI and [¹⁸F]FDG PET as input gave the highest correlation coefficient.

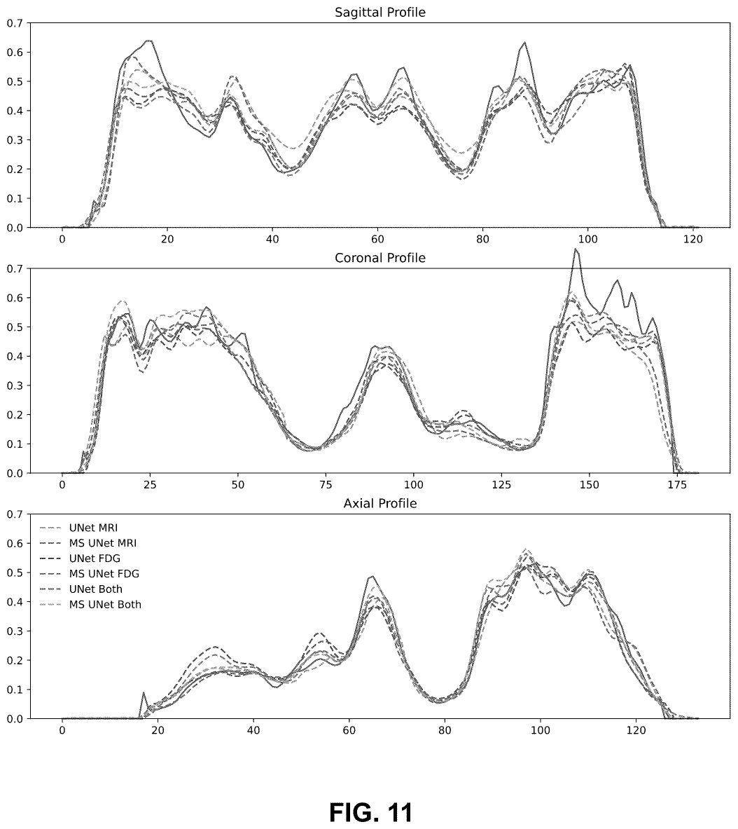

FIG. 11 shows the predicted image profiles of all six models. The solid blue line is the ground truth. The profiles of the images were plotted from the central slice of the sagittal, coronal, and axial planes. From the image profiles, it can be seen that the predicted [¹¹C]UCB-J PET image followed the trend of the real image but was less shaper than the ground truth. The prediction made by MS U-Net using both inputs was the closest to the ground truth, which demonstrates that MS U-Net has higher prediction accuracy compared to U-Net.

### Discussion

In the present example, by generating synthetic [¹¹C]UCB-J images, an accessible way of offering additional clinical information on the underlying pathology for certain neurological disorders such as AD was proposed, which accessible way is without additional radiation exposure and cost by synthesizing images. The utilization of 3D convolutional multi-stage U-net with residual blocks, feature fusion and attention mechanism proved to be a viable approach for cross-modality translation. Based on the qualitative observations and quantitative evaluations, it was found that the model was able to learn the nonlinear mapping between the [¹¹C]UCB-J images and the T1-weighted MR images and/or [¹⁸F]FDG PET images robustly.

Regarding the input images, it was found that using [¹⁸F]FDG PET gave slightly better synthetic [¹¹C]UCB-J image with proper training, potentially due to it containing more functional and metabolic information. On the one hand, using [¹⁸F]FDG PET alone or in combination with T1w MRI to generate [¹¹C]UCB-J PET resulted in highly robust and accurate outcomes, which can reduce radiation for patients and monitor disease progression. Also, MRI-based predictions eliminated the risk of radiation exposure completely. This approach can be easily applied to any patient and may be particularly useful for evaluating therapeutic responses especially for institutions where [¹¹C]UCB-J tracers are not readily available. Similar networks could be applied to other imaging modalities and extended to participants with other diseases as well.

### CONCLUSION

It is feasible to produce high-quality and reliable synthetic SV2A PET images using MRI and/or [¹⁸F]FDG PET scans for both HC and AD participants. Integrating T1w MRI with [¹⁸F]FDG PET images yielded accurate [¹¹C]UCB-J PET images using a properly trained deep learning model. The multi-stage U-net effectively captured the complex relationships between different imaging modalities and outperformed the traditional single-stage U-net in synthesizing images. The trained models were able to learn and reflected the differences in SV2A changes associated with AD.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A computer-implemented method of training a model to generate positron emission tomography (PET) images from magnetic resonance imaging (MRI) images, the method comprising:
selecting a healthy dataset, the healthy dataset including paired MR and PET images from healthy subjects;
selecting a target dataset, the target dataset including paired MR and PET images from subjects having a condition corresponding to a biomarker of interest;
creating a training dataset from the combination of healthy dataset and the target dataset;
training a machine learning model using the training dataset.

2. The method of claim 1, wherein MR images comprise at least one MR sequence image.

3. The method of claim 2, wherein the MR sequence image comprises an MR T1 image, or MR T2 image, or a combination of images acquired using more than one MR sequences.

4. The method of claim 1, wherein the biomarker of interest is a synaptic density tracer.

5. The method of claim 4, wherein the biomarker of interest is synaptic vesicle protein 2A (SV2A).

6. The method of claim 1, wherein the condition is a brain disorder.

7. The method of claim 6, wherein the brain disorder a neuropsychiatric disorder.

8. The method of claim 7, wherein the neuropsychiatric disorder is selected from the group consisting of Alzheimer's disease, mild cognitive impairment, major depressive disorder, schizophrenia, post-traumatic stress disorder, autism spectrum disorders, anxiety disorders, bipolar disorder and substance use disorders.

9. The method of claim 8, wherein the substance use disorder is cannabis use disorder.

10. The method of claim 1, wherein the machine learning model comprises a deep learning model.

11. The method of claim 10, wherein the deep learning model comprises an encoder-decoder with 3D convolution layers with ReLU activation operators.

12. The method of claim 1, wherein the machine learning model comprises a deep convolution neural network or a diffusion network.

13. The method of claim 1, wherein the machine learning model comprises a network model trained using:
a. MR T1 or T2 to BP 60 PET image;
b. MR T1 or T2 to BP 90 PET image; or
c. MR T1 or T2 to distribution volume ratio (DVR) PET image; or
d. MR T1 or T2 to SUV PET image.

14. The method of one of claim 1, wherein the training comprises patch-based training.

15. The method of claim 14, wherein the patch-based training comprises extracting at least four random patches for each epoch from each training image.

16. The method of claim 1, wherein the MR and PET images are subjected to preprocessing prior to training the machine learning model.

17. The method of claim 16, wherein the preprocessing comprises segmentation and co-registration of the MR and PET images.

18. A method of generating positron emission tomography (PET) images from magnetic resonance imaging (MRI), the method comprising:
obtaining a MR image from a subject; and
applying the model trained according to claim 1 to the MR image.

19. The method of claim 18, wherein the MR image comprises at least one MR T1 image or at least one MR T2 image.

20. The method of claim 18, wherein the subject is a low-dose subject and the MR image is converted to a higher quality PET image than true PET.

21. A computer-implemented method of training a model to generate positron emission tomography (PET) images from multimodal input images, the method comprising:
selecting a healthy dataset, the healthy dataset including paired PET and multimodal images from healthy subjects;
selecting a target dataset, the target dataset including paired PET and multimodal images from subjects having a condition corresponding to a biomarker of interest;
creating a training dataset from the combination of healthy dataset and the target dataset;
training a machine learning model using the training dataset.

22. The method of claim 21, wherein the multimodal input images comprise anatomical imaging modalities and/or functional imaging modalities.

23. The method of claim 21, wherein the multimodal input images are selected from at least two imaging modalities selected from the group consisting of magnetic resonance imaging (MRI), PET, computed tomography (CT), single photon emission computed tomography (SPECT), electroencephalography data (EEG), magnetic encephalography data (MEG), near-infrared spectroscopy imaging (NIRS), and functional near-infrared spectroscopy imaging (fNIRS).

24. The method of claim 23, wherein the MR images comprise at least one MR sequence image.

25. The method of claim 24, wherein the MR sequence image comprises an MR T1 image, or MR T2 image, or a combination of images acquired using more than one MR sequences.

26. The method of claim 21, wherein the biomarker of interest is a synaptic density tracer.

27. The method of claim 26, wherein the biomarker of interest is synaptic vesicle protein 2A (SV2A).

28. The method of claim 21, wherein the condition is a brain disorder.

29. The method of claim 28, wherein the brain disorder a neuropsychiatric disorder.

30. The method of claim 29, wherein the neuropsychiatric disorder is selected from the group consisting of Alzheimer's disease, mild cognitive impairment, major depressive disorder, schizophrenia, post-traumatic stress disorder, autism spectrum disorders, anxiety disorders, bipolar disorder and substance use disorders.

31. The method of claim 30, wherein the substance use disorder is cannabis use disorder.

32. The method of claim 21, wherein the machine learning model comprises a deep learning model.

33. The method of claim 32, wherein the deep learning model comprises a multi-stage U-net with 3D convolutional layers.

34. The method of claim 32, wherein the deep learning model comprises a cross-stage feature fusion (CSFF) strategy.

35. The method of claim 32, wherein the deep learning model comprises a supervised attention module (SAM).

36. The method of claim 21, wherein the machine learning model comprises a deep convolution neural network or a diffusion network.

37. The method of claim 21, wherein the training comprises patch-based training.

38. The method of claim 37, wherein the patch-based training comprises extracting at least four random patches for each epoch from each training image.
